(19) United States
(12) Patent Application Publication
(10) Pub. No.: US 2024/0119472 A1
(43) Pub. Date: Apr. 11, 2024

(54) ASSOCIATING GROUPS OF CONSUMERS WITH TRANSACTIONS USING VIDEO DATA AND LOCATION INFORMATION

(71) Applicant: Insight Direct USA, Inc., Chandler, AZ (US)

(72) Inventor: Amol Ajgaonkar, Chandler, AZ (US)

(21) Appl. No.: 18/376,516

(22) Filed: Oct. 4, 2023

Related U.S. Application Data
(60) Provisional application No. 63/413,296, filed on Oct. 5, 2022.

(51) Int. Cl. G06Q 30/0204; G06K 7/10; G06K 19/07; G06V 20/40; G06V 20/50; G06V 40/10; H04W 4/021

(52) U.S. Cl. CPC G06Q 30/0204; G06K 7/10297; G06K 7/10316; G06K 19/0723; G06V 20/41; G06V 20/50; G06V 40/10; H04W 4/021

(57) ABSTRACT

A system for identifying a group of consumers and associating a first purchase with the group that includes a purchase terminal at which the first purchase is made by a first consumer in the group of consumers; an RF tag having identification information and configured to move in unison with the first consumer; a first RF antenna configured to record a location of the RF tag via reception of the identification information from the RF tag; at least one camera configured to collected video data of the group of consumers within an entrance/exit zone; and a computer processor in communication with the purchase terminal, the RF antenna, and the at least one camera. The computer processor can be configured to identify a number of consumers within the group from the video data, collect the location and the identification information of the first RF tag from the RF antenna, receive information regarding the first purchase, associate the RF tag with the information regarding the first purchase, and associate the information regarding the first purchase by the first consumer with the group of consumers.

### CROSS-REFERENCE TO RELATED APPLICATIONS

This application is a nonprovisional application claiming the benefit of U.S. provisional application Ser. No. 63/413,296, filed on Oct. 5, 2022, entitled “ASSOCIATING GROUPS OF CONSUMERS WITH TRANSACTIONS USING VIDEO DATA AND LOCATION INFORMATION” by Amol Ajgaonkar.

### FIELD OF THE INVENTION

This disclosure relates generally to the sale/purchase of products and/or services and, more specifically, to associating individuals' demographic information with in-person transactions/purchases. Additionally, this disclosure relates to identifying a group of individuals/consumers and associating the number of individuals/consumers with in-person transactions/purchases by any of the members of the group.

### BACKGROUND

In a retail setting, such as a physical store, individuals/consumers purchase products and/or services. A purchase can be associated with an individual/consumer if the individual has a consumer account or enters personal information at a purchase terminal. However, it is difficult to determine any other information about the consumer. Additionally, some stores may find it useful to count the number of individuals/consumers that enter the store over a period of time and compare that number to the number of purchases/sales to determine a sales conversion rate. The conversion rate may be inaccurate if a group of individuals/consumers enter the store intending to collectively make only one or a few purchases. In this instance, the conversion rate will inaccurately reflect that the other individuals/consumers in the group are not associated with a purchase.

### SUMMARY

Systems and methods are disclosed herein that identify/collect demographic information of consumers and associate the demographic information with the consumer and/or a purchase by the consumer. Additionally, the disclosed systems and methods can identify a group of individuals/consumers (e.g., consumers that are shopping together) and associate the number of consumers with the purchase and/or with the consumer within the group that made the purchase. Thus, demographic information of consumers as well as the whether the consumers are part of a group shopping together can be associated with a purchase and/or with the consumer(s) making the purchase.

The system includes a camera in communication with a computer processor, which can have computer vision, with the computer processor configured to determine consumers that are associated with one another so as to form a group. The computer processor can also be configured to analyze consumers to determine demographic information of the consumers. The system can also include radio frequency (hereinafter “RF”) tags to associate products and/or services with transactions regarding a consumer. The RF tags work in conjunction with at least one RF antenna to track the consumer within the store and/or record when the consumer is within a field of view of the camera so as to associate the consumer with the information determined by the computer processor from the video data. The camera and RF antenna can convey information to the computer processor, which can be configured to associate the number of consumers within the group and/or the demographic information with the consumer, the purchase by the consumer, the product/service that was purchased, and/or any other relevant information and/or metadata. This information can be stored in a database to allow for access, analysis, and manipulation of the information by users.

The demographic information being associated with the purchase (which includes information regarding the purchased products and/or service)s can lead the retail store (or a chain/franchise of retail stores) to be able to make inferences regarding the demographic profile of people purchasing particular products and/or services. A determination of the number of groups of consumers instead of simply just the number of consumers/individuals entering/exiting the retail store is important for an accurate determination of the sales conversion rate. The number of groups of consumers compared to the number of purchases is a more accurate determination of the sales conversion rate. Additionally, the sales conversion rate along with the demographic information can be analyzed to determine which demographics are purchasing products and/or services and which demographics are not making any (or very few) purchases.

The purchase(s) made by the consumer, demographic information of the consumer and other consumers in the group, information regarding the products and/or services being purchased, and the information regarding the number of consumers in a group can be used by the retail store (or chain/franchise or retail stores) for a variety of purposes/inferences. For example, if a retail store is in an area that includes a lot of people that are part of a particular demographic and that demographic purchases a particular product and/or service more than other demographics, the retail store may desire to have more inventory of that product and/or service. For a chain/franchise of retail stores, other retail stores that are in a similar area may also desire to carry more inventory of that product and/or service based on the information from the other, similarly situated retail store. The information regarding the conversion rate of groups of consumers vs. total sales/purchases can be used to improve sales techniques, such as increasing the suggestion/recommendation of a particular product and/or service to consumers having a particular demographic. These and other advantages of the disclosed systems and methods will be realized after reviewing the below disclosure.

In one example, a system for collecting demographic information and associating the demographic information with a purchase by a consumer is disclosed that includes an RF tag having identification information associated with the purchase by the consumer and configured to move in unison with the consumer, a first RF antenna configured to record a location of the RF tag via reception of the identification information from the RF tag, a camera configured to collected video data including the consumer, and a computer processor configured to receive location information and the identification information of the RF tag from the first RF antenna, receive information regarding the purchase and associate the RF tag with the information regarding the purchase, and receive video data from the camera. The computer processor can be configured to determine demographic information of the consumer from the video data and associate the demographic information with the information regarding the purchase.

In another example, a system for collecting demographic information and associating the demographic information with multiple products purchased by multiple consumers is disclosed that includes a first retail store that has a first RF tag associated with a first product purchased by a first consumer with the first RF tag having first identification information and configured to move in unison with the first product; a first RF antenna configured to record a location of the first RF tag within the first retail store via reception of the first identification information from the first RF tag; a first camera configured to collect first video data including the first consumer; and a first computer processor configured to receive location information and the first identification information of the first RF tag from the first RF antenna, receive information regarding the first purchase and associate the first RF tag with the first purchase, and receive first video data from the first camera. The first computer processor can be configured to determine demographic information of the first consumer from the first video data and associate the demographic information with the information regarding the first purchase. The system can also include a second retail store that has a second RF tag associated with a second product purchased by a second consumer with the second RF tag having second identification information and configured to move in unison with the second product; a second RF antenna configured to record a location of the second RF tag within the second retail store via reception of the second identification information from the RF tag; a second camera configured to collect second video data including the second consumer; and a second computer processor configured to receive location information and the second identification information of the second RF tag from the second RF antenna, receive information regarding the second purchase and associate the second RF tag with the second purchase, and receive second video data from the second camera. The second computer processor can be configured to determine demographic information of the second consumer from the second video data and associate the demographic information with the information regarding the second purchase.

In another example, a system for identifying a group of consumers and associating a first purchase with the group is disclosed that includes a purchase terminal at which the first purchase is made by a first consumer in the group of consumers; an RF tag having identification information and configured to move in unison with the first consumer; a first RF antenna configured to record a location of the RF tag via reception of the identification information from the RF tag; at least one camera configured to collected video data of the group of consumers within an entrance/exit zone; and a computer processor in communication with the purchase terminal, the RF antenna, and the at least one camera. The computer processor can be configured to identify a number of consumers within the group from the video data, collect the location and the identification information of the first RF tag from the RF antenna, receive information regarding the first purchase, associate the RF tag with the information regarding the first purchase, and associate the information regarding the first purchase by the first consumer with the group of consumers.

In another example, a process of identifying a group of consumers and associating a first purchase with the group is disclosed that includes processing the first purchase by a first consumer in the group of consumers; associating information regarding the first purchase with an RF tag that is configured to move in unison with the first consumer; tracking a location of the RF tag; collecting video data of the group of consumers within an entrance/exit zone by at least one camera; identifying, by a computer processor, a number of consumers within the group of consumers from the video data; and associating the group of consumers with information regarding the first purchase by the first consumer.

### BRIEF DESCRIPTION OF THE DRAWINGS

FIG. 1 is an example schematic of a retail store showing a system for associating individuals and groups of individuals with purchases and demographic information.

FIG. 2A is a first example of group identification using boundary boxes.

FIG. 2B is a second example of group identification using boundary boxes.

FIG. 2C is a third example of group identification using boundary boxes.

FIG. 3 is an example of demographic information identification.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

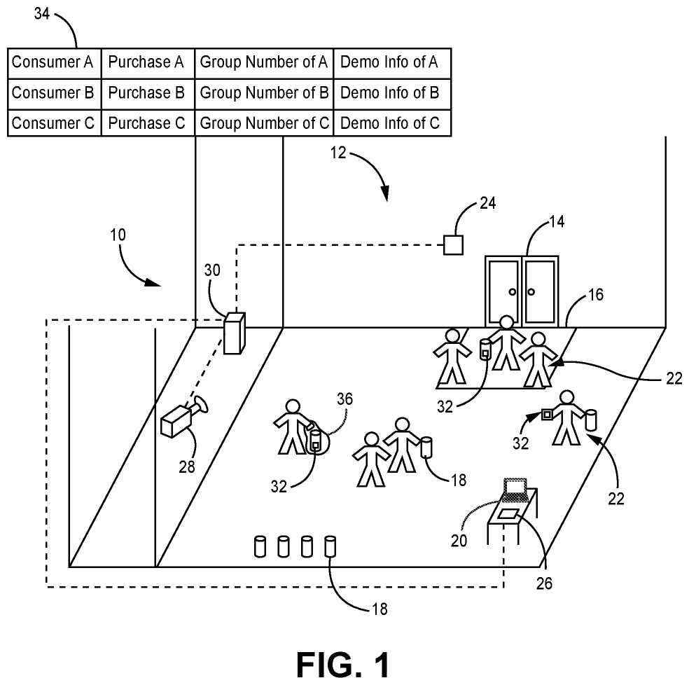

FIG. 1 is an example schematic of a retail store showing a system for associating individuals with purchases and/or demographic information as well as for identifying groups of individuals and associating the groups with the purchases and/or demographic information. System 10 can be located within retail store 12. Retail store 12 can include entrance/exit door 14 (also referred to just as door 14), entrance/exit zone 16, products 18, and purchase terminal 20. Within retail store 12 can be one or multiple consumers 22. System 10 can include first radio frequency “RF” antenna 24, second RF antenna 26, camera 28, computer processor 30, one or multiple RF tags 32, and database 34. Products 18, once purchased, can be placed in bags 36.

System 10 can include other components not expressly disclosed herein that are suitable for performing the functions of system 10 and associated methods. For example, system 10 can include additional computer processors, a user interface that allows access to and/or manipulation of information in database 34, storage media, and communication device(s) for viewing, sending, receiving, and storing information electronically.

System 10 can be used in conjunction with (i.e., at least partially within) retail store 12. Retail store 12 as shown in FIG. 1 is configured to sell products 18. However, retail store 12 can be configured to sell services or both products 18 and services. Products 18, when used in this description, includes any products and/or services offered for sale and able to be purchased by consumers 22 (even if it is not a “product”). In the situation where retail store 12 sells services, RF tags 32 can be attached to/incorporated into a physical receipt that is provided to consumer 22 purchasing the service as the time of the transaction. Example products 18 are shown in FIG. 1 as being cylinders, but products 18 can be anything offered for sale and able to be purchased by consumers 22. Additionally, “consumer” is used in this disclosure to represent any individual that is not an employee of retail store 12, whether the individual purchases product 18 or not. Consumer 22 does not necessarily need to enter retail store 12 if retail store 12 has a configuration that allows for consumer 22 to examine and/or purchase products 18 without entering retail store 12.

Retail store 12 can be configured to have a consumer/customer area within which consumers 22 are able to move and examine products 18. Retail store 12 can also be configured to have an employee area within which consumers 22 are not allowed and within which some components of system 10 are present, such as computer processor 30. The consumer area of retail store 12 can be bounded such that consumers 22 can only enter and exit retail store 12 through entrance/exit door 14. Adjacent door 14 is entrance/exit zone 16 at which camera 28 can be pointed to collect video data of consumers 22 entering and exiting retail store 12 to allow for analysis/determinations by computer processor 30 as to whether consumers 22 are part of a group and/or the demographic information of each consumer 22.

Retail store 12 can also include purchase terminal 20, which can be an electronic system that aids in transacting/processing the purchase of products 18 by consumers 22. Purchase terminal 20 can have any configuration known to one of skill in the art, such as a self-checkout feature, a conveyer belt that moves products 18 away from a scanner, a display/interactive screen for use by an employee, etc. Aside from the inclusion of second RF antenna 26 (as described below), purchase terminal 20 can have any configuration and/or features for processing/transacting the purchase of products 18. Purchase terminal 20 can be at any location within retail store 12 but is generally located near door 14 and/or entrance/exit zone 16. As described below, purchase terminal 20 can be in communication with computer processor 30 and/or other components of system 10 to send information regarding the purchase, regarding product 18, and/or regarding consumer 22 to computer processor 30 for association with other information collected and/or determined by system 10.

Retail store 12 can include other configurations, components, and/or features not expressly disclosed or shown herein. Additionally, as is understood by one of skill in the art, retail store 12 can include multiple different products 18 and/or services, and system 10 and associated methods can be used with the sale and purchase of any type of product and/or service by retail store 12 and consumer 22, respectively. Retail store 12 can be one of many retail stores in a “chain” or “franchise” at various locations distant from one another.

Consumers 22 can be any individuals and/or groups of individuals that enter retail store 12. Consumers 22 can purchase product 18, or consumers 22 can merely enter and exit retail store 12 without making a purchase. System 10 can be configured to count and/or identify every consumer 22 that enters/exits retail store 12 to track the total number of consumers 22 that enter retail store 12 to determine such metrics as number of sales per consumer 22 and/or per group of consumers 22.

Most or all of the components of system 10 are within and/or associated with retail store 12. If multiple systems 10 are used with multiple retail stores 12 as part of a chain/franchise, the information collected/determined by each system 10 at each retail store 12 can be aggregated into database 34.

RF tags 32 are each associated with a purchase of product 18. RF tags 32 are configured to allow for tracking/locating/recording the location of product 18 and/or consumer 22 before and/or after the purchase of product 18 to which RF tag 32 is associated. RF tags 32 can be affixed to product 18, affixed to a physical receipt that is given to consumer 22 after the purchase, placed into or affixed to bag 36 into which product 18 is placed after the purchase, or otherwise associated with product 18 and/or consumer 22 after the purchase of product 18. RF tags 32 can be associated with each product 18 before the purchase or at the time of purchase, such as by an employee of retail store 12 affixing or otherwise associating RF tag 32 with product 18 and consumer 22. While RF tags 32 are disclosed herein as utilizing radio frequency to allow for tracking/locating of RF tags 32, any other type of wireless tracking technology can be used by RF tags 32 in association with first and second RF antennas 24 and 26, respectively. RF tags 32 can allow for tracking of each RF tag 32, and thus consumer 22 that is carrying or otherwise associated with RF tag 32, throughout retail store 32. Additionally and/or alternatively, RF tags 32 can allow for locating/recording of each RF tag 32 when RF tag 32 (and thus consumer 22) is within a designated zone, such as entrance/exit zone 16 as consumer 22 is exiting retail store 12. RF tags 32 can have any configurations and capabilities as are known to one of ordinary skill in the art. RF tags 32 can allow for tracking/locating even after each RF tag 32 (and thus consumer 22) has exited retail store 12, or RF tags 32 can deactivate and/or be out of range of first and/or second RF antennas 24 and 26, respectively, once each RF tag 32 has been removed from retail store 12. RF tags 32 can be configured to store any information regarding product 18, consumer 22, the purchase of product 18 by consumer 22, and/or other information and/or metadata. Additionally, RF tags 32 can each include an identification/serial number that is sent to/retrieved by first and/or second RF antenna 24 and 26, respectively.

RF tags 32 can each have identification information that uniquely identifies each individual RF tag 32. This identification information can be received and/or otherwise accessed by RF antennas 24 and/or 26 to determine the location of each RF tag 32 and/or to associate each RF tag 32 with product 18, consumer 22, and/or a purchase. For example, first R

First RF antenna 24 is located within retail store 12 and is configured to track the location of one or multiple RF tags 32 each associated with consumer 22 and/or product 18 before and/or after the purchase or product 18. First RF antenna 24 can also be configured to record when each RF tag 32 is within a particular area, such as entrance/exit zone 16, and convey that information to computer processor 30 so that computer processor 30 can associate that information/RF tag 32 with video data of that particular area collected by camera 28.

First RF antenna 24 can have any configuration to allow for wireless communication/tracking of RF tags 32. While first RF antenna 24 is disclosed herein as utilizing radio frequency to track the location of RF tags 32, any other type of wireless tracking technology can be used by first RF antenna 24 to track tags 32. First RF antenna 24 can be located anywhere throughout retail store 12. In one example, first RF antenna 24 is located near door 14 and/or entrance/exit zone 16. First RF antenna 24 can be in wired or wireless communication with computer processor 30 to convey information regarding the location of each RF tag 32 and potentially other information regarding product 18, consumer 22, and/or the purchase of product 18 by consumer 22 that is collected from RF tags 32.

Second RF antenna 26 can be located at/incorporated into purchase terminal 20 and/or is in communication with purchase terminal 20. Second RF antenna 26 can be configured to associate the purchase of product 18 with RF tag 32. Second RF antenna 26 can have a flat configuration that is placed on a counter of purchase terminal 20, with RF tag 32 being slid across second RF antenna 26 before being affixed to, placed in bag 36 with, or otherwise associated with product 18.

In one example, consumer 22 brings product 18 to purchase terminal 20 to buy product 18. While consumer 22 and/or product 18 are at purchase terminal 20, RF tag 32 is placed adjacent to second RF antenna 26. Then, second RF antenna 26 can load/transfer/transmit onto RF tag 32 any information and metadata associated with the purchase of product 18, included a model number of product 18, the time and date of the transaction, any known information about consumer 22, and/or other information and/or metadata. When RF tag 32 comes within range of first RF antenna 24, this information can be transferred/transmitted/communicated to first RF antenna 24, which then can communicate this information to computer processor 30, which can associate this information with video data received from camera 28 (as described below).

In another example, second RF antenna 26 and/or purchase terminal 20 can be configured to be in communication with computer processor 30 (and/or other components of system 10) to send information to computer processor 30 regarding products 18, consumers 22, the purchase of product 18 by consumers 22, RF tags 32 (such as identification/serial numbers), and/or any other information and/or metadata. Then, RF tags 32 can be configured to only store identification/serial number information designating each particular RF tag 32, and first RF antenna 24 can merely be configured to record a location of RF tag 32 and relay that location as well as the particular RF tag 32 identification/serial number information. Computer processor 30 can then link the information received from second RF antenna 26 and/or purchase terminal 20 with the information from first RF antenna 24 regarding the location of RF tag 32. With the location information from first RF antenna 24, computer processor 30 can link video data from camera 28, analyze the video data to determine if consumers 22 are part of a group and/or determine demographic information of each consumer 22, and link that group and/or demographic information to the information regarding product 18, consumer 22, the purchase of product 18 by consumer 22, and/or any other information and/or metadata.

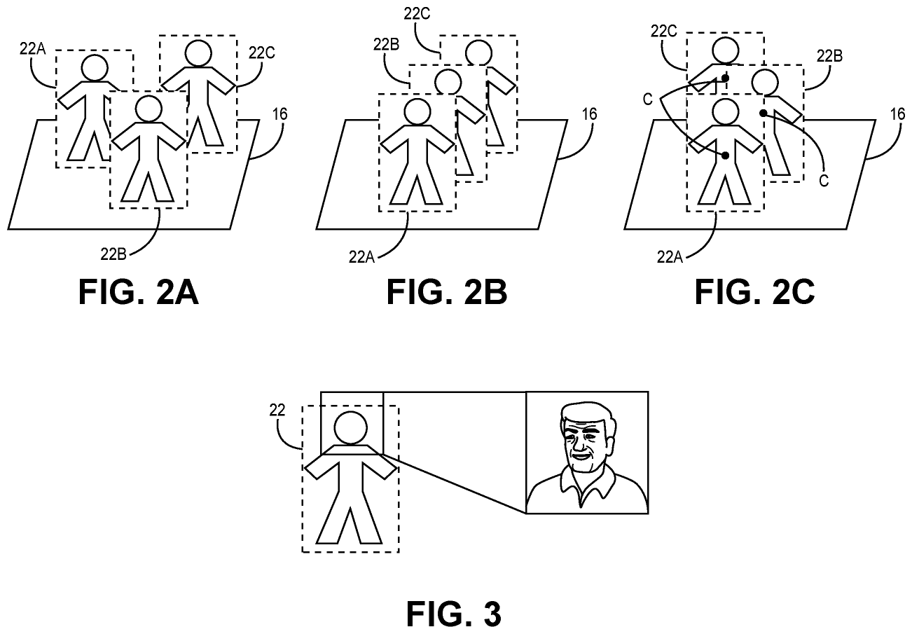

Camera 28 can be located within retail store 12 and configured to collect video data that includes consumer 22. As described with regards to FIGS. 2A-2C and 3, camera 28 can collect and communicate/transmit video data to computer processor 30. Camera 28 can be configured to have a field of view that is the entirety of the customer/consumer area of retail store 12 or a zone that has less area, such as entrance/exit zone 16. Camera 28 is in wired or wireless communication with computer processor 30 to convey the video data to computer processor 30. Camera 28 can have any configuration and capabilities known to one of ordinary skill in the art for collecting/recording video data and communicating/transmitting that video data to computer processor 30.

Computer processor 30 can be in communication with purchase terminal 20, first RF antenna 24, second RF antenna 26, and/or camera 28. Computer processor 30 can receive from purchase terminal 20, first RF antenna 24, and/or second RF antenna 26 any information and/or metadata associated with product 18, consumer 22, the purchase of product 18, and/or RF tag 32. Additionally, computer processor 30 can receive from first RF antenna 24 tracking/location information of RF tag 32 associated with consumer 22 and/or product 18. Moreover, computer processor can receive from camera 28 video data that includes consumer 22. From this information, metadata, and/or video data, computer processor 30 can be configured to determine the number of individuals/consumers 22 within a group as well as determine demographic information of each individual/consumer 22 and associate this information with the purchase of product 18 and/or with consumer 22.

As described in regards to FIGS. 2A-2C and 3 below, computer processor 30 can include any hardware and/or software, such as computer vision, for analyzing video data collected by camera 28 and determining whether consumers 22 in the video data are in a group and/or demographic information of consumers 22. The components of computer processor 30 can be designed/organized in any configuration to perform the functions described herein. Computer processor 30 can include one or multiple computer/data processors. In general, the computer/data processors 30 can include any or more than one of a processor, a microprocessor, a controller, a digital signal processor (DSP), an application specific integrated circuit (ASIC), a field-programmable gate array (FPGA), or other equivalent discrete or integrated logic circuitry. Computer processor 30 can perform instructions stored within storage media (or located elsewhere), and computer processor 30 can include storage media such that computer processor 30 is an all-encompassing component able to store instructions and perform the functions described herein. Additionally, computer processor 30 can perform other computing processes, such as performing instructions for the display, manipulation, and or analysis of database 34.

System 10, including computer processor 30 and database 34, can also include or function in association with machine-readable storage media. In some examples, a machine-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, storage media can be entirely or in part a temporary memory, meaning that a primary purpose storage media is not long-term storage. Storage media, in some examples, is described as volatile memory, meaning that the memory, does not maintain stored contents when power to system 10 (or the component(s) where storage media are located) is turned off. Examples of volatile memories can include random access memories (RAM), dynamic random-access memories (DRAM), static random-access memories (SRAM), and other forms of volatile memories. In some examples, storage media can also include one or more machine-readable storage media. Storage media can be configured to store larger amounts of information than volatile memory. Storage media can further be configured for long-term storage of information. In some examples, storage media include non-volatile storage elements. Examples of such non-volatile storage elements can include magnetic hard discs, optical discs, flash memories and other forms of solid-state memory, or forms of electrically programmable memories (EPROM) or electrically erasable and programmable (EEPROM) memories. Most generally, storage media is machine-readable data storage capable of housing stored data from a stored data archive. Storage media can be configured handle any digital/electronic storage needs for system 10.

Database 34 can be and/or include a digital/electronic storage and/or organizational structure to store and/or associate the information and/or metadata regarding product 18, consumer 22, the purchase of product 18 by consumer 22, the number of consumers 22 in the group, and/or demographic information of the consumer 22 and/or others in the group. Database 34 can be in communication with computer processor 30 to receive all information and/or metadata collected and/or determined by system 10, such as any information regarding product 18 (e.g., model number), consumer 22 (including demographic information and/or the number of individuals in the group with consumer 22), the purchase of product 18 by consumer 22 (e.g., date product 18 was purchased, and in which retail store 12 product 18 was purchased), and/or RF tags 32 (e.g., a identification/serial number of RF tag 32). Database 34 can be configured to allow a user to view, analyze, and/or manipulate all information and/or metadata collected and/or determined by system 10. Database 34 can include multiple different views that each can be configured to the preferences of a user to display a variety of different information/metadata. As with the other components of system 10, database 34 can be located on multiple devices (e.g., computers/hardware) and/or accessible from multiple devices so that multiple users can view, analyze, and/or manipulate the information/metadata from system 10.

FIGS. 2A-2C show examples of group identification by computer processor 30 from video data collected by camera 28 showing entrance/exit zone 16. FIGS. 2A-2C is one frame of video data collected by camera 28 showing entrance/exit zone 16 of retail store 12. In entrance/exit zone 16 are consumer 22A, consumer 22B, and consumer 22C. While FIGS. 2A-2C show one frame of video data collected by camera 28, computer processor 30 can be configured to analyze multiple frames for group identification, and computer processor 30 can be configured to select one or multiple frames from video data that are most indicative of whether consumers 22A-22C are in a group together.

Computer processor 30, during analysis/determination of the number of consumers 22 in the group, can digitally/electronically draw a boundary box around each consumer 22A-22C as each consumer 22A-22C passes through entrance/exit zone 16. The boundary boxes can be drawn in a variety of configurations. For example, the boundary boxes can be drawn so as to fully encompass each of consumers 22A-22C or encompass only a head and torso of each consumer 22A-22C. However, the size of the boundary box can be a factor in determining whether consumers 22 are in a group. From the boundary boxes, computer processor 30, which can include computer vision, can then determine if consumers 22A-22C are part of a group and, if so, the number of individuals/consumers 22A-22C that are in the group.

In the first example shown in FIG. 2A, computer processor 30 identifies a group when one boundary box drawn around each of consumers 22A-22C overlaps with another boundary box around each of consumer 22A-22C. In this first example, the boundary box of consumer 22A overlaps with the boundary box of consumer 22B, and the boundary box of consumer 22B overlaps with the boundary box of consumer 22C. Because the boundary boxes only need to overlap any portion of another boundary box, computer processor 30 determines that the number of consumers 22A-22C in the group is three. The group will include any consumers 22A-22C that have a portion of the boundary box that overlaps with any other boundary box. System 10 can be configured such that consumers 22A-22C get linked together into a single group if one consumer 22 (e.g., consumer 22B) is overlapped with multiple consumers (e.g., consumers 22A and 22C) even though consumer 22A does not overlap with consumer 22C.

In the second example shown in FIG. 2B, computer processor 30 identifies a group when 25% of an area of one boundary box drawn around each of consumers 22A-22C overlaps with another boundary box of any one of consumers 22A-22C. In this example, the boundary box of consumer 22A overlaps with the boundary box of consumer 22B such that 25% of the areas of the boundary boxes overlap, and the boundary box of consumer 22B overlaps with the boundary box of consumer 22C such that 25% of the areas of the boundary boxes overlap. As with the first example above, system 10 can be configured such that consumers 22A-22C get linked together into a single group if one consumer 22 (e.g., consumer 22B) is overlapped by more than 25% area with multiple consumers (e.g., consumers 22A and 22C) even though consumer 22A does not overlap by more than 25% area with consumer 22C. In other configurations, computer processor 30 can identify a group when any percentage of an area of one boundary box drawn around each of consumers 22A-22C overlaps with another boundary box of any one of consumers 22A-22C. In another example, the percentage of area that must overlap for a group to be identified is greater than 40%.

In the third example shown in FIG. 2C, computer processor 30 identifies a group when a center C of one boundary box drawn around each of consumers 22A-22C overlaps with another boundary box of any one of consumers 22A-22C. In this example, the center C of the boundary box of consumer 22A overlaps with the boundary box of consumer 22B, the center C of the boundary box of consumer 22B overlaps with the boundary box of consumer 22A, and the center C of the boundary box of consumer 22C overlaps with the boundary box of consumer 22B. As with the first and second examples above, system 10 can be configured such that consumers 22A-22C get linked together into a single group if one consumer 22 (e.g., consumer 22B) has a center C that overlaps with multiple consumers (e.g., consumers 22A and 22C) even though consumer 22A has a center C that does not overlap with consumer 22C.

The methods of identifying groups set out in FIGS. 2A-2C are only examples, and system 10, including computer processor 30, can identify groups of consumers 22 using other methods. The components of system 10, including camera 28, can have different configurations to collect video data for use in identifying groups of consumers 22. For example, camera 28 can have a field of view that encompasses more than entrance/exit zone 16 such that video data includes consumers 22 for an entirety or a large portion of the time consumers 22 are within retail store 12. Then, computer processor 30 can determine, from interactions between consumers 22 shown the video data, if any of consumers 22 are within a group and, if so, the number of consumers 22 within the group.

FIG. 3 is an example of determining demographic information of consumer 22 from video data collected by camera 28. Computer processor 30 can draw a boundary box around consumer 22 and analyze consumer 22 within the boundary box to determine the demographic information of consumer 22. Computer processor 22 can enlarge and/or otherwise manipulate/alter the video data to better analyze/determine the demographic information of consumer 22. In the example in FIG. 3, computer processor 30 enlarges a head/face of consumer 22. The demographic information can include any inferences made by computer processor 30 about consumer 22, such as consumer 22: age, race, ethnicity, and/or gender. While FIG. 3 shows only one frame of video data, computer processor 30 can be configured to analyze multiple frames to determine demographic information. For example, computer processor 30 can be configured to select multiple frames from video data that show different views of consumer 22, such as a front view, side views, and/or a back view to determine demographic information.

The demographic information can be determined from video data collected when consumers 22 are within entrance/exit zone 16, or the demographic information can be determined from video data when consumers 22 are at another location within retail store 12. For example, system 10 can include camera 28 that is pointed at purchase terminal 20 so as to collect video data of consumer 22 when consumer 22 is making a transaction/purchasing product 18. In this example, system 10 can include two cameras 28: one camera that is directed/pointed at entrance/exit zone 16 to collect video data for computer processor 30 to identify groups of consumers 22 and one camera that is directed/pointed at purchase terminal 20 to collect video data for computer processor 30 to determine demographic information of consumers 22.

System 10 collects/determines demographic information of consumer 22 and associates the demographic information of consumer 22 with product 18, consumer 22, and/or a purchase of product 18 by consumer 22 (e.g., a consumer profile). System 10 can be within one or multiple retail stores 12 and have RF tags 32 each associated with a purchase of product 18 by consumer 22 and each configured to move in unison with consumer 22 after the purchase. System 10 can also include first RF antenna 24 configured to track a location of RF tags 32 and/or record when RF tags 32 are within a designated area, such as entrance/exit zone 16. System 10 can further include camera 28, which is configured to collect video data that includes consumer 22, and compute processor 30, which is configured to receive location information of RF tags 32 from first RF antenna 24 and receive video data from camera 28 and determine demographic information of consumer 22 from the video data and associate the demographic information with product 18, consumer 22, the purchase of product 18 by consumer 22, and/or other information and/or metadata. Computer processor 30 can also be configured to identify whether consumer 22 is in a group of/consumers 22 and, if so, identify the number of consumers 22 in the group as well as associating the group information (e.g., whether consumer 22 is alone or in a group and the number of consumers in the group) with product 18, consumer 22, and/or the purchase of product 18 by consumer 22.

System 10 can include second RF antenna 26 that is configured to associate information regarding the purchase, product 18, and/or consumer 22 with RF tag 32 at the time of purchase. This information can then be conveyed to first RF antenna 24 when RF tag 32 comes into range of first RF antenna 24. Another configuration/example of system 10 can have second RF antenna 26 in communication with purchase terminal 20, second RF antenna 26 in communication with computer processor 30, and/or purchase terminal 20 in communication with computer processor 30. When product 18 is purchased, information regarding the purchase, product 18, consumer 22, and RF tag 32 associated with product 18 (including an identification/serial number or other means of identifying RF tag 32) are sent/communicated to computer processor 30 by one of second RF antenna 26 and purchase terminal 20. Then, first RF antenna 24 tracks/locates RF tag 32 with a particular identification/serial number and sends that information to computer processor 30. Computer processor 30 can be configured to link the tracking information of RF tag 32 (as designated by the identification/serial number) with the information regarding the purchase, product 18, consumer 22, etc. that is designated with/linked to the identification/serial number of RF tag 32. In this example, RF tag 32 does not need to store/convey all of the information regarding the purchase, product 18, consumer 22, etc. and rather that information is sent to computer processor 30 by second RF antenna 26 and/or purchase terminal 20.

The following are nonlimiting examples of system 10, related processes of collecting/determining demographic information and associating the demographic information with a purchase of product 18 by consumer 22, and related processes of identifying a group of consumers 22 and associating a purchase of product 18 with the group and/or consumer 22:

A system for identifying a group of consumers and associating a first purchase with the group that includes a purchase terminal at which the first purchase is made by a first consumer in the group of consumers; an RF tag having identification information and configured to move in unison with the first consumer; a first RF antenna configured to record a location of the RF tag via reception of the identification information from the RF tag; at least one camera configured to collected video data of the group of consumers within an entrance/exit zone; and a computer processor in communication with the purchase terminal, the RF antenna, and the at least one camera. The computer processor can be configured to identify a number of consumers within the group from the video data, collect the location and the identification information of the first RF tag from the RF antenna, receive information regarding the first purchase, associate the RF tag with the information regarding the first purchase, and associate the information regarding the first purchase by the first consumer with the group of consumers.

The system can further include that the computer processor forms a boundary box around each consumer present within the video data.

The system can further include that the computer processor identifies the group when one boundary box overlaps with another boundary box around each consumer of the group of consumers.

The system can further include that a group is identified when more than 25% of an area of one boundary boxes overlap with another boundary box around each consumer of the group of consumers.

The system can further include that a group is identified when a center of an area of one boundary box overlaps with another boundary box around each consumer of the group of consumers.

The system can further include a second RF antenna in communication with the purchase terminal.

The system can further include that the second RF antenna receives the identification information from the RF tag.

The system can further include that the second RF antenna is in communication with the computer processor and sends the identification information from the RF tag and the information regarding the first purchase to the computer processor.

The system can further include a retail store within which the entrance/exit zone is located.

The system can further include that the first RF antenna is configured to track the location of the RF tag within the retail store.

The system can further include that the RF tag is one of the following: the RF tag is affixed to a physical receipt for the purchase, the RF tag is affixed to a product that is a focus of the purchase, and the RF tag is associated with a bag in which the product that is the focus of the purchase is located.

The system can further include that the computer processor is configured to determine demographic information of at least one consumer of the group of consumers from the video data.

The system can further include that the computer processor associates the demographic information with the first purchase.

The system can further include a database in communication with the computer processor, the database storing information regarding the first purchase and the group of consumers.

A process of identifying a group of consumers and associating a first purchase with the group includes processing the first purchase by a first consumer in the group of consumers; associating information regarding the first purchase with an RF tag that is configured to move in unison with the first consumer; tracking a location of the RF tag; collecting video data of the group of consumers within an entrance/exit zone by at least one camera; identifying, by a computer processor, a number of consumers within the group of consumers from the video data; and associating the group of consumers with information regarding the first purchase by the first consumer.

The process can further include that the step of identifying the number of consumers within the group further comprises forming a boundary box around each consumer present within the video data.

The process can further include that the step of identifying the number of consumers within the group further comprises identifying the group when one boundary box of one consumer overlaps with another boundary box of another consumer.

The process can further include determining, from the video data, demographic information of at least one consumer of the group of consumers.

The process can further include that, in response to the RF tag being within the entrance/exit zone, the information regarding the first purchase on the RF tag is associated with the group of consumers within the entrance/exit zone.

The process can further include providing the number of consumers within the group of consumers and information regarding the first purchase to a database.

A system for collecting demographic information and associating the demographic information with a purchase by a consumer includes an RF tag having identification information associated with the purchase by the consumer and configured to move in unison with the consumer, a first RF antenna configured to record a location of the RF tag via reception of the identification information from the RF tag, a camera configured to collected video data including the consumer, and a computer processor configured to receive location information and the identification information of the RF tag from the first RF antenna, receive information regarding the purchase and associate the RF tag with the information regarding the purchase, and receive video data from the camera. The computer processor can be configured to determine demographic information of the consumer from the video data and associate the demographic information with the information regarding the purchase.

The system can further include a purchase terminal at which the purchase is made by the consumer and at which the identification information of the RF tag is associated with information regarding the purchase.

The system can further include a second RF antenna at the purchase terminal that associates the RF tag with the information regarding the purchase.

The system can further include a second RF antenna in communication with the computer processor and configured to send information regarding the purchase to the computer processor.

The system can further include a retail store within which the first RF antenna and the camera are located.

The system can further include that the camera collects video data of the consumer within an entrance/exit zone adjacent a door of the retail store.

The system can further include that the first RF antenna is configured to record the location of the RF tag when the RF tag is within the entrance/exit zone.

The system can further include that the RF tag is affixed to a product that is the focus of the purchase.

The system can further include that the RF tag is affixed to a physical receipt for the purchase.

The system can further include that the RF tag is associated with a bag in which a product that is the focus of the purchase is located.

The system can further include that the computer processor uses computer vision to determine the demographic information.

The system can further include that the computer processor is distant from the first RF antenna and the camera.

The system can further include a database in communication with the computer processor, the database storing the information regarding the consumer, the information regarding the purchase, and the demographic information.

A system for collecting demographic information and associating the demographic information with multiple products purchased by multiple consumers include a first retail store that has a first RF tag associated with a first product purchased by a first consumer with the first RF tag having first identification information and configured to move in unison with the first product; a first RF antenna configured to record a location of the first RF tag within the first retail store via reception of the first identification information from the first RF tag; a first camera configured to collect first video data including the first consumer; and a first computer processor configured to receive location information and the first identification information of the first RF tag from the first RF antenna, receive information regarding the first purchase and associate the first RF tag with the first purchase, and receive first video data from the first camera. The first computer processor can be configured to determine demographic information of the first consumer from the first video data and associate the demographic information with the information regarding the first purchase. The system can also include a second retail store that has a second RF tag associated with a second product purchased by a second consumer with the second RF tag having second identification information and configured to move in unison with the second product; a second RF antenna configured to record a location of the second RF tag within the second retail store via reception of the second identification information from the RF tag; a second camera configured to collect second video data including the second consumer; and a second computer processor configured to receive location information and the second identification information of the second RF tag from the second RF antenna, receive information regarding the second purchase and associate the second RF tag with the second purchase, and receive second video data from the second camera. The second computer processor can be configured to determine demographic information of the second consumer from the second video data and associate the demographic information with the information regarding the second purchase.

The system can further include a database in communication with the first computer processor and the second computer processor, the database including the demographic information of the first consumer and the second consumer and information regarding the first purchase and the second purchase, respectively.

The system can further include that the first computer processor and the second computer processor are incorporated into one component.

The system can further include that the first retail store has a first purchase terminal at which the first product is purchased by the first consumer and at which the first RF tag is associated with information regarding the first purchase.

The system can further include that the first purchase terminal conveys information regarding the first consumer to the first computer processor and the computer processor associates the information regarding the first consumer with the information regarding the first purchase.

The system can further include that the information regarding the first consumer includes at least one of a name of the first consumer, contact information of the first consumer, and purchase history of the first consumer.

The system can further include that the first computer processor is located distant from the first retail store and the second computer processor is located distant from the second retail store.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system for identifying a group of consumers and associating a first purchase with the group, the system comprising:
a purchase terminal at which the first purchase is made by a first consumer in the group of consumers;
an RF tag having identification information and configured to move in unison with the first consumer;
a first RF antenna configured to record a location of the RF tag via reception of the identification information from the RF tag;
at least one camera configured to collected video data of the group of consumers within an entrance/exit zone; and
a computer processor in communication with the purchase terminal, the RF antenna, and the at least one camera, the computer processor configured to identify a number of consumers within the group from the video data, collect the location and the identification information of the RF tag from the first RF antenna, receive information regarding the first purchase, associate the RF tag with the information regarding the first purchase, and associate the information regarding the first purchase by the first consumer with the group of consumers.

2. The system of claim 1, wherein the computer processor forms a boundary box around each consumer present within the video data.

3. The system of claim 2, wherein the computer processor identifies the group when one boundary box overlaps with another boundary box around each consumer of the group of consumers.

4. The system of claim 3, wherein a group is identified when more than 25% of an area of one boundary boxes overlap with another boundary box around each consumer of the group of consumers.

5. The system of claim 3, wherein a group is identified when a center of an area of one boundary box overlaps with another boundary box around each consumer of the group of consumers.

6. The system of claim 1, further comprising:
a second RF antenna in communication with the purchase terminal.

7. The system of claim 6, wherein the second RF antenna receives the identification information from the RF tag.

8. The system of claim 6, wherein the second RF antenna is in communication with the computer processor and sends the identification information from the RF tag and the information regarding the first purchase to the computer processor.

9. The system of claim 1, further comprising:
a retail store within which the entrance/exit zone is located.

10. The system of claim 9, wherein the first RF antenna is configured to track the location of the RF tag within the retail store.

11. The system of claim 1, wherein the RF tag is one of the following: the RF tag is affixed to a physical receipt for the purchase, the RF tag is affixed to a product that is a focus of the purchase, and the RF tag is associated with a bag within which the product that is the focus of the purchase is located.

12. The system of claim 1, wherein the computer processor is configured to determine demographic information of at least one consumer of the group of consumers from the video data.

13. The system of claim 12, wherein the computer processor associates the demographic information with the first purchase.

14. The system of claim 1, further comprising:
a database in communication with the computer processor, the database storing information regarding the first purchase and the group of consumers.

15. A method of identifying a group of consumers and associating a first purchase with the group, the method comprising:
processing the first purchase by a first consumer in the group of consumers;
associating information regarding the first purchase with an RF tag that is configured to move in unison with the first consumer;
tracking a location of the RF tag;
collecting video data of the group of consumers within an entrance/exit zone by at least one camera;
identifying, by a computer processor, a number of consumers within the group of consumers from the video data; and
associating the group of consumers with information regarding the first purchase by the first consumer.

16. The method of claim 15, wherein the step of identifying the number of consumers within the group further comprises:
forming a boundary box around each consumer present within the video data.

17. The method of claim 16, wherein the step of identifying the number of consumers within the group further comprises:
identifying the group when one boundary box of one consumer overlaps with another boundary box of another consumer.

18. The method of claim 15, further comprising:
determining, from the video data, demographic information of at least one consumer of the group of consumers.

19. The method of claim 15, wherein, in response to the RF tag being within the entrance/exit zone, the RF tag is associated with the group of consumers within the entrance/exit zone.

20. The method of claim 15, further comprising:
providing the number of consumers within the group of consumers and information regarding the first purchase to a database.
